(19) United States
(12) Patent Application Publication
(10) Pub. No.: US 2025/0261806 A1
(43) Pub. Date: Aug. 21, 2025

(54) EXPANDABLE CADDY

(71) Applicant: Ginsey Industries, Inc., Swedesboro, NJ (US)

(72) Inventors: Chris Greco, Swedesboro, NJ (US); Simon LI, Swedesboro, NJ (US)

(21) Appl. No.: 19/022,158

(22) Filed: Jan. 15, 2025

Related U.S. Application Data
(60) Provisional application No. 63/554,445, filed on Feb. 16, 2024.

(51) Int. Cl. A47J 47/20

(52) U.S. Cl. CPC A47J 47/20

(57) ABSTRACT

The present disclosure pertains to an in-sink caddy designed for optimizing kitchen sink space. In some embodiments, an in-sink caddy comprising a main body with a base and a plurality of upright walls; a slide-out tray with a base, configurable to a stowed position beneath the main body and expanded positions extending horizontally outwardly from the main body, wherein in the expanded position the slide-out tray is configured to function as an auxiliary area suitable for drying kitchen tools; and a slide track system facilitating the selective movement of the slide-out tray.

### CROSS REFERENCE TO RELATED APPLICATIONS

This application claims priority to U.S. Provisional Patent Application Ser. No. 63/554,445, filed on Feb. 16, 2024, entitled EXPANDABLE CADDY, which is hereby incorporated by reference in its entirety.

### FIELD

The present disclosure pertains to the field of kitchen accessories and, more specifically, to apparatuses designed for the storage, organization, and drying of kitchen utensils and sponges within a sink environment.

### BACKGROUND

Kitchen spaces often suffer from clutter and inefficient use of space, especially in and around the sink area where sponges, scrubbers, and other cleaning tools are commonly used. Conventional solutions include various in-sink organizers that attempt to address the storage and drying of utensils and sponges. However, these conventional solutions frequently fall short in providing a balance between space efficiency, cleanliness, and ease of access.

A common shortfall of conventional in-sink caddies is their fixed size and shape, which does not accommodate the varying dimensions and designs of sinks, nor are they able to adjust to the changing storage needs of users. These caddies often have limited or inefficient drainage systems, leading to water accumulation and the potential for unsanitary conditions due to stagnant water and the associated growth of bacteria and mold. Furthermore, the attachment mechanisms of existing caddies often lack the versatility for secure repositioning, which can be helpful to cater to the changing preferences of users. Moreover, many available caddy designs do not incorporate materials that inhibit microbial growth, leaving the stored items susceptible to unsanitary conditions.

Thus, there is a need for improvement in the field of kitchen sink accessories to provide an organization system that maximizes space efficiency while also promoting cleanliness and user convenience.

### SUMMARY

In some embodiments, an in-sink caddy comprising a main body with a base and a plurality of upright walls; a slide-out tray with a base, configurable to a stowed position beneath the main body and expanded positions extending horizontally outwardly from the main body, wherein in the expanded position the slide-out tray is configured to function as an auxiliary area suitable for drying kitchen tools; and a slide track system facilitating the selective movement of the slide-out tray.

In some embodiments, the slide track system further comprises at least one slide track aperture on the main body's base and at least one latch on the slide-out tray. In some embodiments, the at least one latch comprises at least one post that extends vertically from the slide-out tray's base and a ridge that protrudes horizontally from the top of the post and can engage with a central support on the main body's base via the slide track aperture. In some embodiments, the ridge, by engaging with the central support through the slide track aperture, is configured to glide along the central support, allowing the slide-out tray to horizontally extend and retract relative to the main body's base, thereby allowing for adjustment of the position of the slide-out tray.

In some embodiments, the main body has a recessed section on the lower portion of its front face and its front corners. In some embodiments, the recessed section is configured to correspond to the shape of the slide-out tray, such that the main body and the slide-out tray present a substantially co-planar outer surface when the caddy is in the stowed position. In some embodiments, the caddy further comprises ridges on the recessed front corners of the main body. In some embodiments, the slide-out tray further comprises a front face extending vertically from its front edge, the height of which does not exceed the height of the recessed section at the lower portion of the main body's front face. In some embodiments, the slide-out tray further comprises corner supports, the corner supports comprising open, semi-circular top contours; and semi-cylindrical support structures that extend vertically upwards from the base of the slide-out tray, positioned at the front corners, and taller than the vertical height of the slide-out tray's front face.

In some embodiments, the main body forms therethrough a plurality of wall perforations for air circulation and water drainage. In some embodiments, the plurality of wall perforations are arranged in parallel lines.

In some embodiments, the caddy further comprises a detachable docking pad, the docking pad including at least one hook mechanism for engaging with an open space on the main body's back wall. In some embodiments, the docking pad is larger than the open space on the main body's back wall. In some embodiments, the docking pad further comprises an adhesive backing for attachment of the docking pad to the wall of a sink. In some embodiments, the adhesive backing on the docking pad is repositionable, allowing for the docking pad to be detached and reattached to the sink wall multiple times.

In some embodiments, the base of the main body further forms therethrough a plurality of drainage perforations.

In some embodiments, the base of the slide-out tray forms therethrough a plurality of drainage perforations arranged linearly in staggered rows. In some embodiments, the plurality of drainage perforations formed therethrough the base of the slide-out tray align with the plurality of drainage perforations formed therethrough the base of the body when the caddy is in the stowed position.

In some embodiments, the main body is sized to accommodate a variety of cleaning tools, including sponges and scrubbers.

In some embodiments, the main body and the slide-out tray comprise one or more materials comprising antimicrobial properties.

This summary is provided to introduce a selection of concepts in a simplified form that are further described below in the detailed description. This summary is not intended to identify key features or essential features of the claimed subject matter, nor is it intended to be used to limit the scope of the claimed subject matter. Additional features and advantages of the disclosed technology will be made apparent from the following detailed description of illustrative embodiments that proceeds with reference to the accompanying drawings.

### BRIEF DESCRIPTION OF THE DRAWINGS

The foregoing and other aspects of the present invention are best understood from the following detailed description when read in connection with the accompanying drawings. For the purpose of illustrating the invention, there are shown in the drawings embodiments that are presently preferred, it being understood, however, that the invention is not limited to the specific instrumentalities disclosed. Included in the drawings are the following Figures:

FIGS. 1A-1B depict perspective views of an in-sink caddy in a closed position and in an open position, respectively, according to embodiments of the disclosure.

FIGS. 2A-2H depict various views of an in-sink caddy in its closed position, according to embodiments of the disclosure.

FIGS. 3A-3D depict various views of an in-sink caddy in its open position, with the docking pad shown exploded out, according to an embodiment of the disclosure.

FIG. 4 shows an in-sink caddy in its closed position and a docking pad, according to an embodiment of the disclosure.

FIGS. 5A and 5B show various views of an in-sink caddy in its open position, according to embodiments of the disclosure.

FIG. 6 shows an in-sink caddy in its open position holding various kitchen items, according to an embodiment of the disclosure.

### DETAILED DESCRIPTION

The present disclosure pertains to an in-sink caddy that enhances kitchen space utilization and promotes cleanliness. The in-sink caddy is compact and expandable, comprising a storage solution that provides an adjustable environment for storing kitchen tools.

In some embodiments, the caddy comprises a main body, a slide-out tray, and a docking pad. The slide-out tray can be selectively positioned in a stowed or expanded configuration. When not in use, the tray can be slid underneath the main caddy body, minimizing the unit's overall size and preserving sink space. In its extended position, the tray can act as an extra drying area, suitable for a variety of kitchen implements.

In some embodiments, the main caddy body further comprises wall perforations on at least one of its walls to facilitate water drainage and air circulation, thereby promoting faster drying of the contents of the caddy and preventing water accumulation that could lead to unsanitary conditions. In some embodiments, the caddy also comprises drainage perforations on both the base of the main caddy body and on the base of the slide-out tray. The main caddy body drainage perforations and the slide-out tray drainage perforations can align when the slide-out tray is in the stowed position.

In some embodiments, the caddy further comprises a docking pad, which allows for secure attachment of the caddy to a sink wall. This docking pad not only stabilizes the caddy but also allows for easy detachment and repositioning of the caddy within the sink. The docking pad can be repositionable to facilitate multiple placements. The docking pad can have a hook that interfaces with an open space, or aperture, formed on the back wall of the main caddy. This configuration allows for easy detachment of the main caddy body from the docking pad.

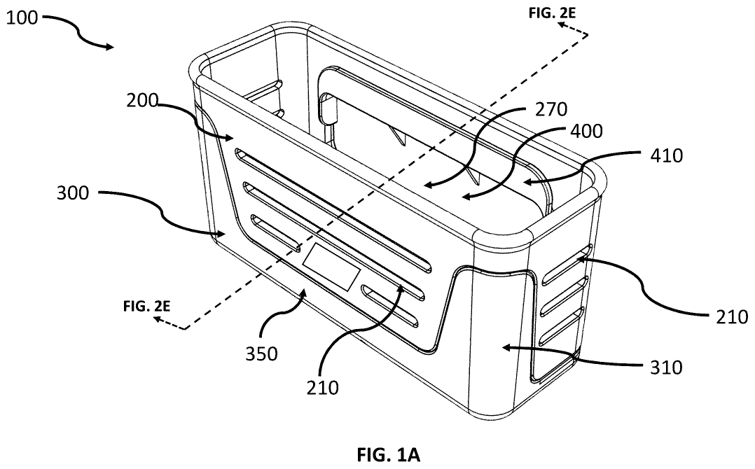

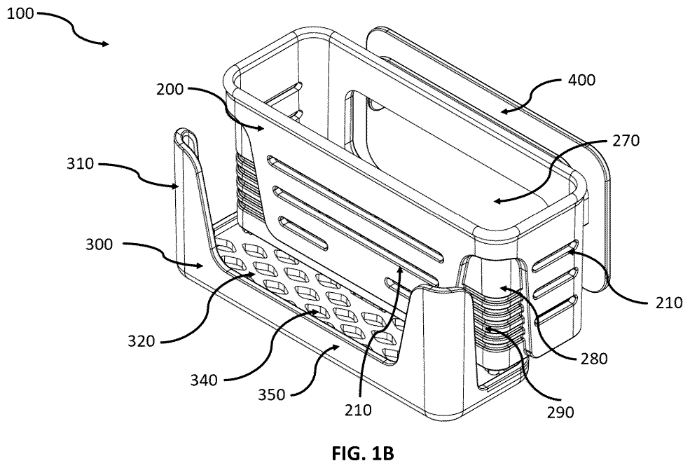

Turning now to the figures, FIGS. 1A-1B depict perspective views of an in-sink caddy in an open position and in a closed position, respectively, according to embodiments of the disclosure. As shown in FIGS. 1A-1B, in some embodiments, the in-sink caddy 100 can comprise a main caddy body 200, a slide-out tray 300, and a docking pad 400.

The main caddy body 200 is the principal storage compartment of the in-sink caddy 100 and is shaped to hold sponges and similar cleaning tools. In some embodiments, the main caddy body 200 features a rectangular profile with an open top.

The slide-out tray 300 is a component that can be maneuvered into stowed or extended positions. In the stowed position, the slide-out tray 300 tucks beneath the main caddy body 200, conserving space within the sink area. When more drying space is required, the tray 300 can slide out to provide additional room for drying larger kitchen tools.

The tray 300 can accommodate various depths between the fully stowed and fully extended positions. This ability to accommodate various depths allows the base 320 to better conform to the unique physical dimensions of the item it is supporting and is also helpful in accommodating the fit of a variety of sink sizes. Additionally, items placed on the corner supports 310 of the tray 300 can be further supported by the ridges 290. A user can thus position the tray 300 to the correct depth such that any item resting on a corner support 300 can make contact with the ridges 290 to prevent sliding out due to weight.

The docking pad 400 is a component to which the entire caddy assembly can attach. It may have a repositionable adhesive backing that can adhere to various sink surfaces. The docking pad 400 further comprises a hook 410 or engagement feature, as depicted in FIG. 1A, that interacts with an opening 270 on the main caddy body 200, securing the main caddy body 200 in place while allowing for easy detachment.

FIG. 1A depicts the caddy 100 in a closed, or stowed, position. FIG. 1B depicts the caddy 100 in an open, or extended, position, showcasing how the slide-out tray 300 offers additional space for storage. In some embodiments, as depicted in FIG. 1B, the slide-out tray 300 can be extended out from under the main caddy body to serve as an auxiliary drying rack. The corner supports 310 are oriented to provide space for kitchen tools and bottles. The perforations 340 in the base 320 of the slide-out tray 300 ensure that water drains away effectively.

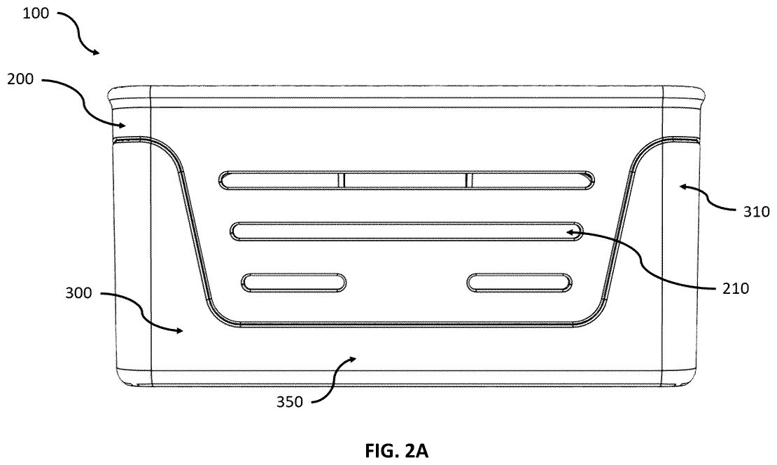

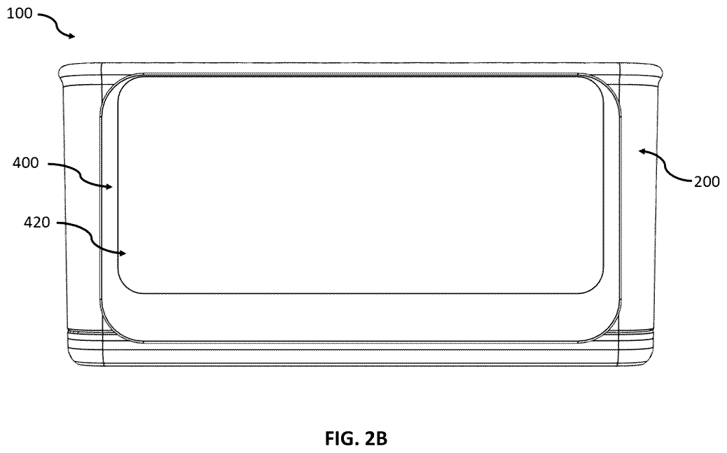

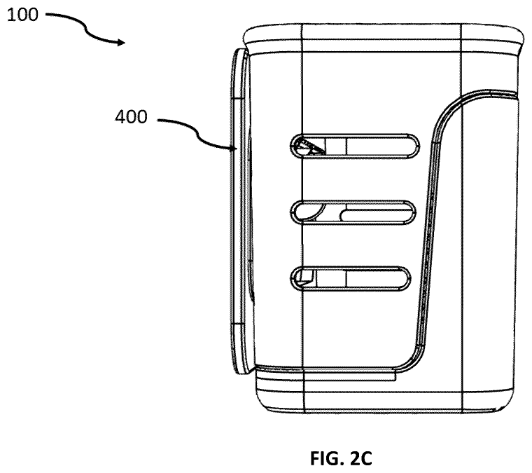

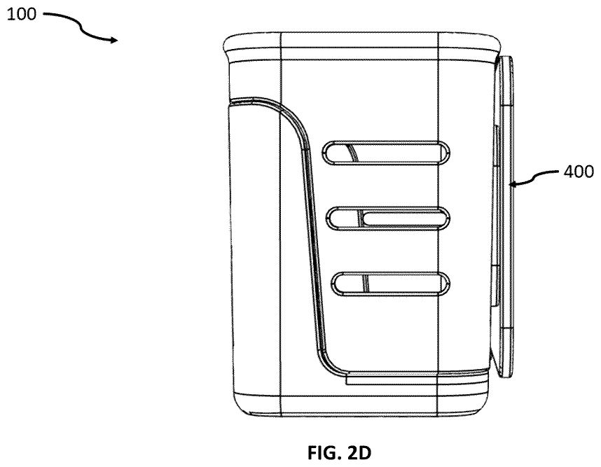

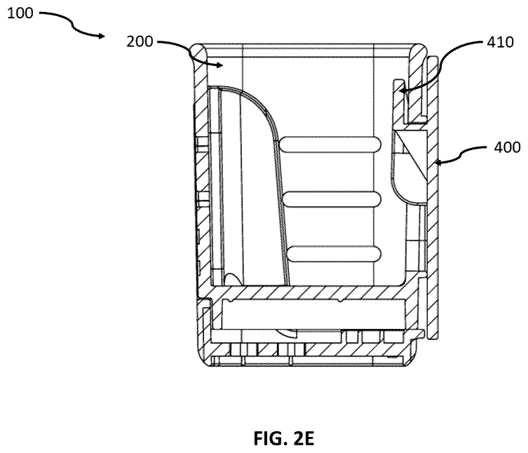

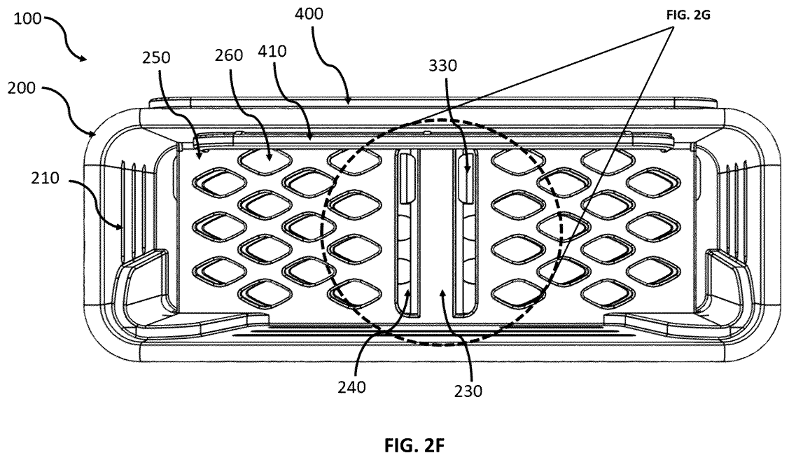

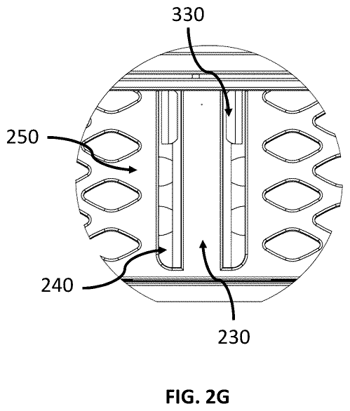

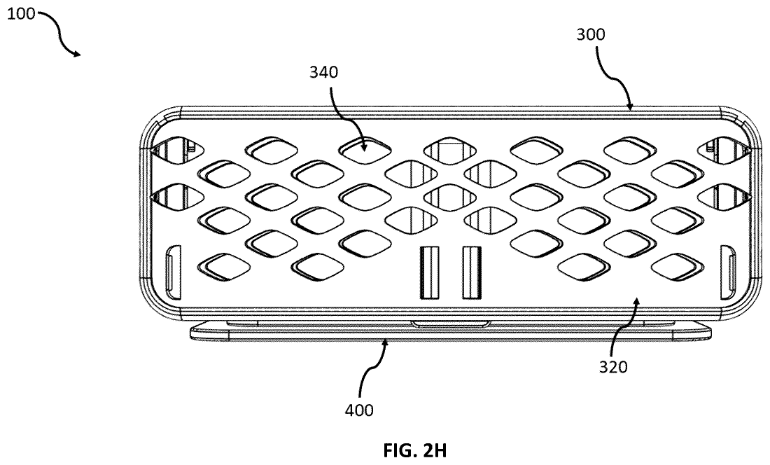

In some embodiments, the main caddy body 200 is rectangular, with an open top and four side walls that rise vertically from a base 250, as best illustrated in FIGS. 1A and 2F. Three of the walls of the main caddy body 200, the front wall and the two side walls, may form therethrough wall perforations 210, allowing for air movement and water drainage, thus promoting quicker drying and a hygienic environment within the main caddy body. In some embodiments, as depicted in FIGS. 1A-1B, these wall perforations 210 are shaped as parallel lines spaced equidistant from each other on the front wall and the two side walls. The fourth wall, the back wall, forms therethrough an opening 270 configured to connect to the docking pad 400.

FIG. 2A depicts a front view of the in-sink caddy 100, illustrating the perforations 210 on the front wall of the main caddy body 200. FIG. 2A also depicts the front facing aspects of the slide-out tray 300.

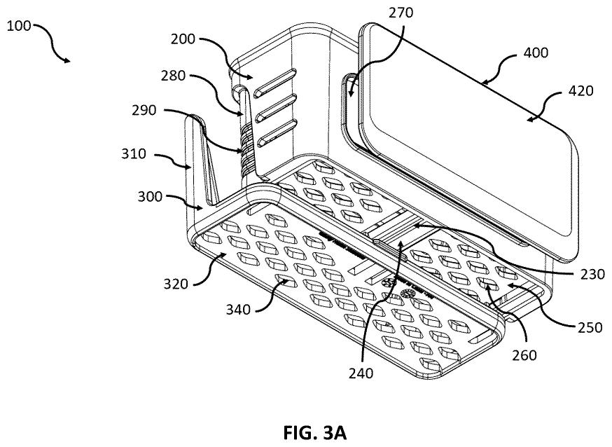

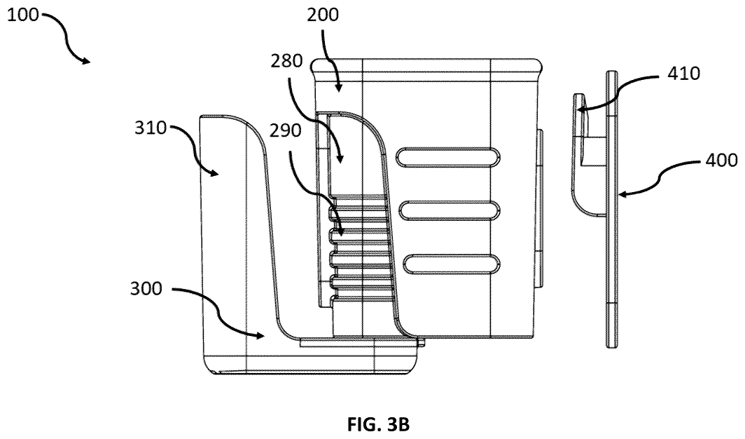

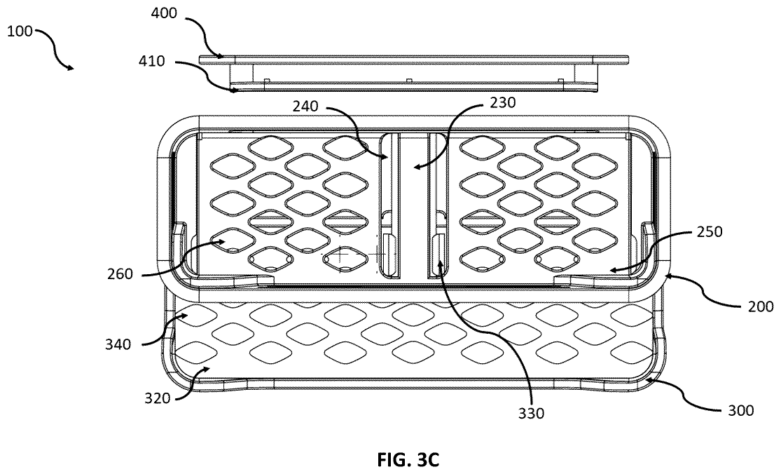

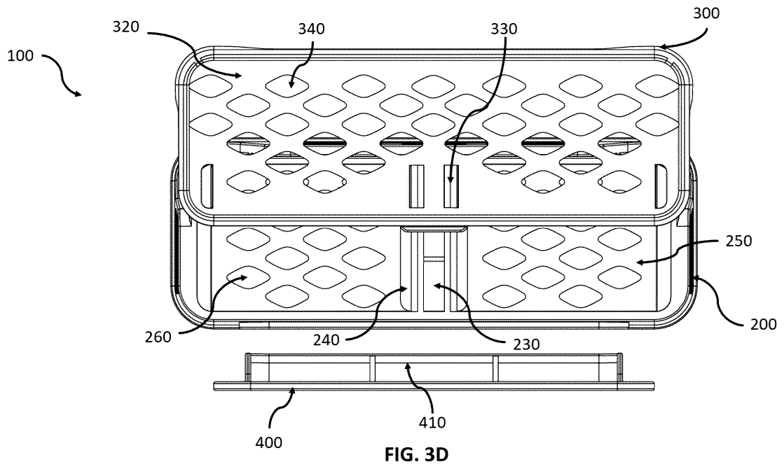

In some embodiments, as depicted in FIGS. 1B, 3A-3B, and 5A, the main caddy body 200 may include recessed sections 280 on its front face and front corners to accommodate the flush alignment of the slide-out tray 300 and the slide-out tray's integrated corner supports 310 when the slide-out tray 300 is stowed. In some embodiments, as depicted in FIG. 1B and FIGS. 3A-3B, the main caddy body 200 further comprises engagement features, or ridges 290, within the recessed front corners 280 of the main caddy body 200. These ridges 290 align with engagement features present on the back of the corner supports 310. When the slide-out tray 300 is in the stowed position, the ridges 290 on both the main caddy body 200 and the corner supports 310 align, ensuring a flush fit with the main caddy body's 200 outer profile and providing additional support for the slide-out tray 300 when it is in the stowed position.

Additionally, the ridges 290 further serve to provide support and stability to items hung from the corner supports 310. For example, if a user hangs an item such as a cup, bottle, or mug from one of the corner supports 310, the item can simultaneously be balanced against one of the ridges 290 such that its movement due to its weight will be prevented.

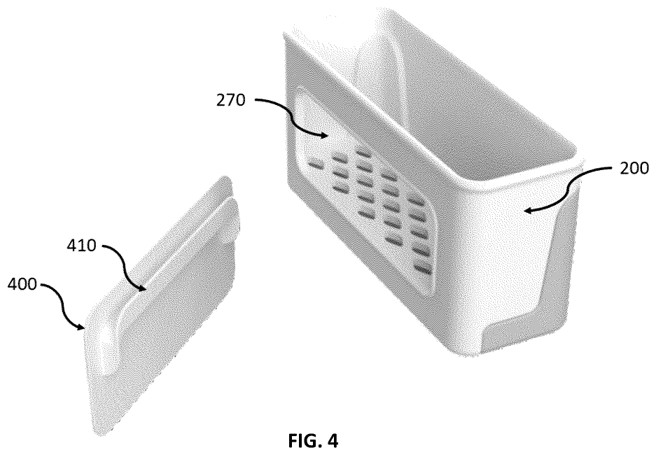

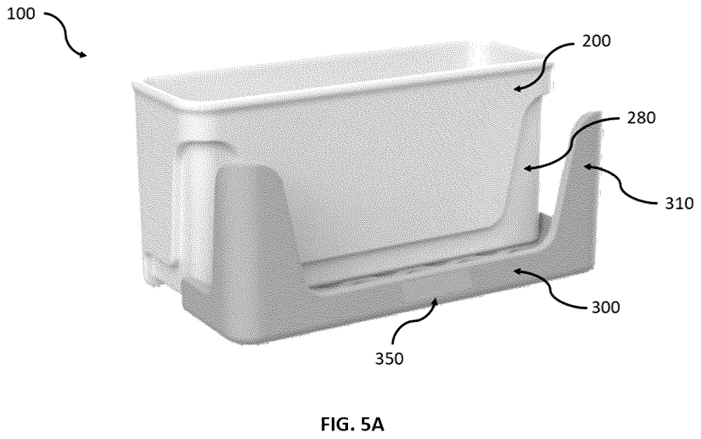

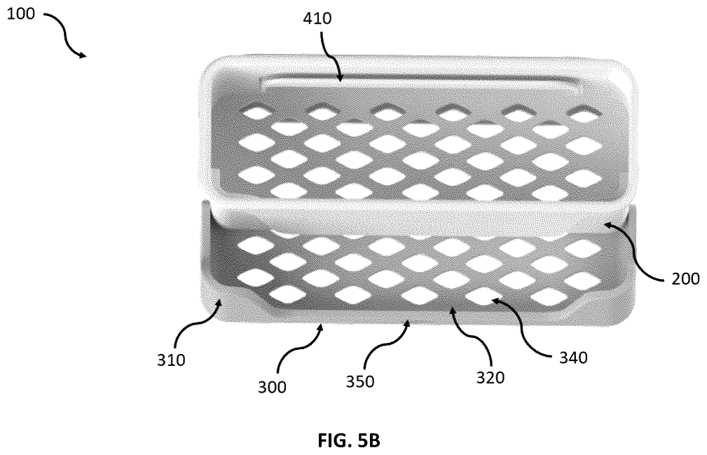

FIG. 4 and FIGS. 5A-5B depict perspective views of embodiments of the in-sink caddy 100. In some embodiments, the main caddy body 200 does not have wall perforations. In some embodiments, the main caddy body 200 does not have engagement features or ridges on the recessed front corners of the main caddy body 200.

In some embodiments, as depicted in FIG. 2F, FIG. 3A, and FIG. 3C, the main caddy body 200 has a base 250 which features a pattern of drainage perforations 260, designed to optimize water drainage while maintaining the supporting function of the base 250. In some embodiments, the drainage perforations 260 may be diamond shaped. In some embodiments, the perforations can be arranged in staggered rows to optimize water drainage while maintaining the supporting function of the base 250.

In some embodiments, the caddy 100 comprises a docking pad 400. Structurally, as depicted in FIG. 2B and FIG. 3A, the docking pad 400 can be substantially planar, rectangular, and sized to cover an area larger than the open space 270 in the back wall of the main caddy body 200, such that the contents within the main caddy body 200 do not come into contact with the sink wall. In some embodiments, as depicted in FIG. 1B, FIGS. 2E-2F, FIGS. 3B-3D, FIG. 4, and FIG. 5B, the docking pad 400 has a hook element 410 on one side. In some embodiments, the hook element is located near the top edge of the docking pad 400. This hook 410 may be elongated, running the entire length of the opening 270, to prevent lateral movement and provide a stable mount. Alternatively, it can comprise a plurality of shorter hooks 410 that function similarly. FIGS. 2C-2D also depict the docking pad 400, situated behind the back wall of the main caddy body 200. In some embodiments, as depicted in FIGS. 2C-2D, the docking pad 400 is slim and unobtrusive, such that the caddy 100 does not protrude unnecessarily into the sink space.

In some embodiments, the main caddy body 200 can hook onto the docking pad 400 at a designated open space 270 that is present on the back wall of the main caddy body 200. In some embodiments, as depicted in FIG. 1A and FIG. 5B, the docking pad 400 has a hook 410 designed to engage with the main caddy body 200 via this open space 270. This interaction is a coupling system that functions through a catch-and-release design, where the hook 410 engages the main caddy body 200 at the open space 270. This hook mechanism provides a secure yet easily detachable connection, allowing the caddy 100 to remain affixed to the docking pad 400, which is attached to the sink wall, even against forces such as water flow and the weight of stored items. The hook itself 410 can withstand repeated use and can bear the weight of the main caddy body 200, the slide-out tray 300, and their contents without compromising the integrity of the docking pad's 400 bond. The hook 410 and open space 270 are proportioned and positioned to distribute the load evenly, preventing any tilting or sagging of the caddy 100 when it is mounted on the sink wall, helping the caddy 100 remain stable and functional, even when fully loaded with wet sponges or heavy utensils.

The ease of removal and reattachment provided by the hook mechanism facilitates cleaning and maintenance of the caddy 100. Users can detach the main caddy body 200 for regular cleaning to maintain hygiene and functionality. Once cleaned, the main caddy body 200 can be easily repositioned back onto the docking pad 400. The main caddy body 200 is depicted in FIG. 2E in a cutaway view, revealing the internal arrangement and structure. As discussed, the hook 410 allows the main caddy body 200 to securely attach to and detach from the docking pad 400.

In some embodiments, as depicted in FIG. 2B and FIG. 3A, the docking pad 400 can include a repositionable adhesive backing 420, allowing the docking pad 400 to be securely attached to the sink wall. The adhesive backing 420 allows for a strong bond to a sink wall without causing damage to the sink. In some embodiments, as depicted in FIG. 2B and FIG. 3A, the adhesive backing 420 is smaller than the docking pad 400. In some embodiments, the adhesive backing 420 is largely rectangular. In some embodiments, the docking pad 400 can easily be removed from the sink wall, permitting readjustment of the caddy 100. The material choice for the adhesive on the back of the docking pad 400 considers the varied environments in which the caddy 100 may be utilized, including exposure to water and the associated temperature fluctuations inherent to kitchen settings. The adhesive material is further characterized by its repositionable nature, allowing the user to adjust the placement of the docking pad 400 as needed.

In some embodiments, the in-sink caddy can include a slide-out tray. In some embodiments, as depicted in FIG. 1B, FIG. 2H, FIG. 3A, FIGS. 3C-3D, and FIG. 5B, the slide-out tray 300 comprises a base 320. In some embodiments, the base may form therethrough a plurality of drainage perforations 340. In some embodiments, the slide-out tray comprises a front wall 350, shaped to be in direct contact and flush alignment with the outer surface of the main caddy body 200 when in the stowed position. In some embodiments, as depicted in FIG. 1B, FIG. 2A and FIGS. 5A-5B, the slide-out tray also comprises a front wall 350 and two front corners, referred to herein as corner supports 310, that extend upward from the base. In the extended position, the front wall 350 and corner supports 310 provide additional support and containment for items placed on the tray, preventing them from slipping off.

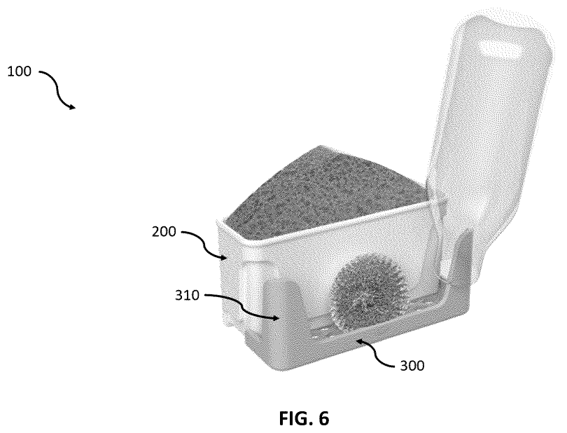

In some embodiments, the slide-out tray can be selectively placed in a stowed position or in an extended position. In the stowed position, as depicted in FIG. 1A and FIG. 2A, the inner surfaces of the front wall 350 and corner supports 310 of the slide-out tray 300 are in contact with the outer surface of the main caddy body 200. In the extended position, as depicted in FIG. 1B, FIGS. 3A-3D, FIGS. 5A-5B, and FIG. 6, the slide-out tray is slid out and away from the main caddy body 200. In a partially extended position, as illustrated in FIG. 6, items can be placed on the base 320 or over the corner supports 310.

As previously discussed, in some embodiments, as depicted in FIG. 1B and 5A, the main caddy body 200 may include recessed sections 280 on its front face and front corners to accommodate the flush alignment of the slide-out tray 300 and the slide-out tray's integrated corner support's 310 when the slide-out tray 300 is retracted.

FIG. 1B depicts the slide-out tray 300. In some embodiments, the slide-out tray 300 includes corner supports 310 at its front corners. The corner supports 310 are characterized by their open, semi-circular top contour and semi-cylindrical support structure, which extends vertically upwards from the slide-out tray's 300 base at the front corners of the slide-out tray 300. The shape of the corner supports 310 allow for the inverted placement of a bottle, ensuring that the neck of the bottle can be seated securely within the semi-circular contour, while the body of the bottle rests against the semi-cylindrical support. FIG. 6 depicts the corner supports 310 in use.

FIG. 2F depicts a top view of the in-sink caddy 100, showing the slide-out tray in its stowed position, according to embodiments of the present disclosure.

In some embodiments, as depicted in FIG. 2F, FIG. 3A and FIGS. 3C-3D, the base 250 of the main caddy body 250 integrates a slide track system that helps to facilitate the movement of the slide-out tray 300. This system comprises a set of parallel apertures, or slide tracks 240, that run longitudinally along a central support 230. In some embodiments, the central support 230 is an aspect of the base 250 of the main caddy body 250 that serves to support loads applied by the slide-out tray 300 and during the slide-out tray's 300 translational motions. In some embodiments, the central support 230 is a beam-like structure formed from a cutout of the base 250 of the main caddy body 200 and is flanked by the two slide tracks 240. In some embodiments, the slide-out tray 300 has at least one latch 330 integrated into its base 320 that engages with the central support 230 through these slide tracks 240, allowing for the back-and-forth sliding motion of the slide-out tray 300. The at least one latch 330 is structurally characterized by a post that extends vertically from the slide-out tray's base 320 and a ridge that protrudes horizontally from the top of the post. This ridge is designed to engage with the central support 230 on the main body's base 250 via the slide track 240.

This design permits the tray 300 to be stowed compactly beneath the main caddy body 200. Conversely, when expanded, it provides an additional area for drying kitchenware. FIG. 2G depicts a detailed view of FIG. 2H, specifically of the central support 230 and slide track mechanism, illustrating how the slide-out tray 300 latches 330 attach to the central support 230 via the slide tracks 240, according to an embodiment of the present disclosure.

In some embodiments, as depicted in FIG. 2H, FIG. 3A, and FIG. 3D, the slide-out tray 300 has a base 320 and drainage perforations 340, which, when in the stowed position, align with the drainage perforations 260 of the base 250 of the main caddy body 200. In some embodiments, the drainage perforations 340 of the slide-out tray 300 may be diamond shaped and they may be arranged in staggered rows to complement the pattern of the drainage perforations 260 on the main caddy body base 250. FIG. 2H depicts a bottom view of the slide-out tray 300, showing the drainage perforations 340, according to embodiments of the present disclosure.

In some embodiments, the materials chosen for both the main caddy body and the slide-out tray are specifically selected for their low-friction characteristics to facilitate the smooth sliding motion of the tray. These materials might include, but are not limited to, certain types of plastics or metal alloys known for their low-resistance traits.

In some embodiments, the material selection for both the main caddy body and the slide-out tray incorporates antimicrobial properties to inhibit the growth of bacteria and mold. The antimicrobial attribute could be a result of an infused agent within the material matrix or a surface treatment that inhibits the growth of bacteria and mold.

FIG. 6 depicts the in-sink caddy 100 in use, holding cleaning tools, according to an embodiment of the present disclosure. In some embodiments, as depicted in FIG. 6, the main caddy body 200 can be occupied by a sponge. In some embodiments, kitchen cleaning items, such as a scrubber, can be placed in the slide-out tray 300 in an extended position. In some embodiments, a bottle can be placed upside-down on top of one of the corner supports 310 to expedite drying. In some embodiments, as depicted in FIG. 6, the tray 300 can be extended only partially, such that any items placed on the corner supports 310 are close enough to the main caddy body 200 that the items can be additionally supported by the main caddy body 200.

### Example Use Case

The following example use case describes how an example of an in-sink caddy according to the present disclosure may be used. This section is intended solely for explanatory purposes and not for limitation.

To initiate the installation of the in-sink caddy, a user could align the docking pad to the desired location on the sink wall, pressing the adhesive backing layer against the sink wall firmly to secure it in place. The main caddy body is then ready for attachment. On its back wall, the main caddy body may feature an open space shaped to accommodate the docking pad's hook element. The user can align this open space above the hook and lower the main caddy body, ensuring that the hook is securely latched onto the main caddy body at this designated open space. This engagement anchors the caddy body to the docking pad, creating a stable unit. The user can now place various items, such as a sponge, in the main caddy body.

As the user begins dishwashing, a sponge can be retrieved from within the main caddy body. This main body can have wall perforations on its front and side walls. After use, the user can place the sponge back in the caddy, where the airflow through the wall perforations and drainage perforations aids in the drying of the sponge, enhancing sanitary conditions and limiting the risk of bacterial growth.

For additional utensils or even a bottle, the user can extend out the slide-out tray by pulling it from underneath the main caddy body. The user can also pull the slide-out tray from its sides or from the corner supports on the front corners of the slide-out tray. Items placed here benefit from the drainage perforations built into the base of the slide-out tray.

After the kitchen work is done, the slide-out tray can be pushed back into its original position, flush with the main body, to maintain a compact profile and to free up space within the sink area. This retractable feature of the tray demonstrates the caddy's adaptable design, catering to the user's space and storage requirements.

The elements of the figures are not exclusive. Other embodiments may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention.

While various illustrative embodiments incorporating the principles of the present teachings have been disclosed, the present teachings are not limited to the disclosed embodiments. Instead, this application is intended to cover any variations, uses, or adaptations of the present teachings and use its general principles. Further, this application is intended to cover such departures from the present disclosure that are within known or customary practice in the art to which these teachings pertain.

In the above detailed description, reference is made to the accompanying drawings, which form a part hereof. In the drawings, similar symbols typically identify similar components, unless context dictates otherwise. The illustrative embodiments described in the present disclosure are not meant to be limiting. Other embodiments may be used, and other changes may be made, without departing from the spirit or scope of the subject matter presented herein. It will be readily understood that various features of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various features. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. It is to be understood that this disclosure is not limited to particular methods, reagents, compounds, compositions or biological systems, which can, of course, vary. It is also to be understood that the terminology used herein is for the purpose of describing particular embodiments only and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention.

In addition, even if a specific number is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, sample embodiments, or drawings, should be understood to contemplate the possibilities of including one of the terms, either of the terms, or both terms. For example, the phrase “A or B” will be understood to include the possibilities of “A” or “B” or “A and B.”

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed.

We claim:

1. An in-sink caddy, comprising:
a main body with a base and a plurality of upright walls;
a slide-out tray with a base, configurable to a stowed position beneath the main body and expanded positions extending horizontally outwardly from the main body, wherein in the expanded position the slide-out tray is configured to function as an auxiliary area suitable for drying kitchen tools; and
a slide track system facilitating the selective movement of the slide-out tray.

2. The caddy of claim 1, wherein the slide track system further comprises at least one slide track aperture on the main body's base and at least one latch on the slide-out tray.

3. The caddy of claim 2, wherein the at least one latch comprises at least one post that extends vertically from the slide-out tray's base and a ridge that protrudes horizontally from the top of the post and can engage with a central support on the main body's base via the slide track aperture.

4. The caddy of claim 3, wherein the ridge, by engaging with the central support through the slide track aperture, is configured to glide along the central support, allowing the slide-out tray to horizontally extend and retract relative to the main body's base, thereby allowing for adjustment of the position of the slide-out tray.

5. The caddy of claim 1, wherein the main body has a recessed section on the lower portion of its front face and its front corners.

6. The caddy of claim 5, wherein the recessed section is configured to correspond to the shape of the slide-out tray, such that the main body and the slide-out tray present a substantially co-planar outer surface when the caddy is in the stowed position.

7. The caddy of claim 6, further comprising ridges on the recessed front corners of the main body.

8. The caddy of claim 6, wherein the slide-out tray further comprises a front face extending vertically from its front edge, the height of which does not exceed the height of the recessed section at the lower portion of the main body's front face.

9. The caddy of claim 8, wherein the slide-out tray further comprises corner supports, the corner supports comprising:
open, semi-circular top contours; and
semi-cylindrical support structures that extend vertically upwards from the base of the slide-out tray, positioned at the front corners, and taller than the vertical height of the slide-out tray's front face.

10. The caddy of claim 1, wherein the main body forms therethrough a plurality of wall perforations for air circulation and water drainage.

11. The caddy of claim 10, wherein the plurality of wall perforations are arranged in parallel lines.

12. The caddy of claim 1 further comprising a detachable docking pad, the docking pad including at least one hook mechanism for engaging with an open space on the main body's back wall.

13. The caddy of claim 12, wherein the docking pad is larger than the open space on the main body's back wall.

14. The caddy of claim 12, wherein the docking pad further comprises an adhesive backing for attachment of the docking pad to the wall of a sink.

15. The caddy of claim 14, wherein the adhesive backing on the docking pad is repositionable, allowing for the docking pad to be detached and reattached to the sink wall multiple times.

16. The caddy of claim 1, wherein the base of the main body further forms therethrough a plurality of drainage perforations.

17. The caddy of claim 1, wherein the base of the slide-out tray forms therethrough a plurality of drainage perforations arranged linearly in staggered rows.

18. The caddy of claim 17, wherein the plurality of drainage perforations formed therethrough the base of the slide-out tray align with the plurality of drainage perforations formed therethrough the base of the body when the caddy is in the stowed position.

19. The caddy of claim 1, wherein the main body is sized to accommodate a variety of cleaning tools, including sponges and scrubbers.

20. The caddy of claim 1, wherein the main body and the slide-out tray comprise one or more materials comprising antimicrobial properties.
